(19) United States
(12) Patent Application Publication
(10) Pub. No.: US 2025/0368067 A1
(43) Pub. Date: Dec. 4, 2025

(54) APPARATUS AND METHOD FOR CONTROLLING ON-BOARD CHARGER

(71) Applicants: Hyundai Motor Company, Seoul (KR); Kia Corporation, Seoul (KR)

(72) Inventors: Byeong Seob Song, Hwaseong-si (KR); Bo Kyung Yoon, Hwaseong-si (KR); Hae Seung Lee, Hwaseong-si (KR); Ho Young Jung, Hwaseong-si (KR)

(21) Appl. No.: 18/968,520

(22) Filed: Dec. 4, 2024

(30) Foreign Application Priority Data
May 28, 2024 (KR) 10-2024-0069139

(51) Int. Cl. B60L 53/22; H02J 7/06; H02M 5/293; H02M 7/219

(52) U.S. Cl. CPC B60L 53/22; H02J 7/06; H02M 5/2932; H02M 7/219; B60L 2210/20; B60L 2210/30; H02J 2207/20

(57) ABSTRACT

An apparatus may perform operations of receiving a voltage value of AC power and a frequency value of the AC power of the on-board charger through a phase lock loop (PLL) to obtain voltage values of active power and reactive power of the AC power, generating a first control signal for controlling first switches including pulse width modulation (PWM) phase control for controlling a direction of power of the AC-AC converter of the on-board charger by determining a sign of an output signal of the PLL, and generating a second control signal for controlling second switches of an AC-DC converter of the on-board charger according to a duty signal generated based on the voltage values of the active power and the reactive power of the AC power, and a preset voltage command value of the active power and a voltage command value of the reactive power thereof.

### CROSS-REFERENCE TO RELATED APPLICATIONS

This application claims the benefit of Korean Patent Application No. 10-2024-0069139, filed on May 28, 2024, which application is hereby incorporated herein by reference.

### TECHNICAL FIELD

The present disclosure relates to an apparatus and method for controlling an on-board charger of a vehicle.

### BACKGROUND

Recently, as interest in the environment has increased, the market for eco-friendly vehicles such as hybrid, electric, and hydrogen fuel cell vehicles is rapidly increasing.

In particular, among these eco-friendly vehicles, plug-in hybrid vehicles (PHEV) and electric vehicles (EV) require a charging device that can receive AC power and can charge a high-voltage battery, to charge such vehicles, which is known as an On Board Charger (OBC).

The above-mentioned on-board charger generally may be comprised of an AC-AC converter for power factor control, an AC-DC converter for output control, an electromagnetic interference (EMI) filter to satisfy electromagnetic wave performance, and the like.

As the on-board charger, a high-performance on-board charger that can perform bi-directional operations due to an increase in battery capacity, wide battery voltage range, and change in charging requirements such as Vehicle to Grid (V2G), and Vehicle to Load (V2L), can be required, and research is being conducted into an on-board charger having a single-stage structure that can perform bi-directional operations, capable of implementing high efficiency/high power density and performing charging/discharging modes to implement the high-performance on-board charger.

The single-stage on-board charger can have a structure that implements the roles of an AC-AC converter and AC-DC converter of the existing two-stage structure on-board charger into a single AC-DC converter. However, it can be difficult to be used under V2L load conditions in which an RLC value is instantaneously converted when controlling the single-stage on-board charger, and there can be a problem in that reactive power may not be performed when an inductive load or capacitive load is connected.

### SUMMARY

According to an embodiment of the present disclosure, an apparatus and method for controlling an on-board charger of an eco-friendly vehicle can be provided, in which an active power axis and a reactive power axis of an AC-DC converter of the on-board charger of the vehicle can be individually controlled, and a switching duty and a switching PWM phase of an AC-AC converter and the AC-DC converter of the on-board charger of the vehicle can be controlled.

According to an embodiment of the present disclosure, an apparatus for controlling an on-board charger of an eco-friendly vehicle can include a processor and a storage medium recording one or more programs configured to be executable by the processor, wherein, when the one or more programs are executed by the processor, the processor may perform operations of: receiving a voltage value of alternating current (AC) power and a frequency value of the AC power of the on-board charger through a phase locked loop (PLL) to obtain a voltage value of active power and a voltage value of reactive power of the AC power; generating a first control signal for controlling the operation of a switch including Pulse Width Modulation (PWM) phase control for controlling a direction of power of an AC-AC converter of the on-board charger by determining a sign of an output signal of the phase locked loop; and generating a second control signal for controlling the operation of a switch of an AC-DC converter of the on-board charger according to a duty signal generated according to the voltage value of the active power and the voltage value of the reactive power of the AC power, and a preset voltage command value of the active power and a voltage command value of the reactive power of the AC power.

According to an embodiment of the present disclosure, a method for controlling an on-board charger of an eco-friendly vehicle can be a method performed in a computing device including a processor and a storage medium recording one or more programs configured to be executable by the processor, and the method can include: receiving a voltage value of alternating current (AC) power and a frequency value of the AC power of the on-board charger through a phase locked loop (PLL) to obtain a voltage value of active power and a voltage value of reactive power of the AC power; generating a first control signal for controlling the operation of a switch including Pulse Width Modulation (PWM) phase control for controlling a direction of power of an AC-AC converter of the on-board charger by determining a sign of an output signal of the phase locked loop; and generating a second control signal for controlling the operation of a switch of an AC-DC converter of the on-board charger according to a duty signal generated according to the voltage value of the active power and the voltage value of the reactive power of the AC power, and a preset voltage command value of the active power and a voltage command value of the reactive power of the AC power.

### BRIEF DESCRIPTION OF THE DRAWINGS

The above and other features and advantages of embodiments of the present disclosure can be more clearly understood from the following detailed description, taken in conjunction with the accompanying drawings, in which:

FIG. 1 is a schematic configuration diagram of an on-board charger system including an apparatus for controlling an on-board charger of an eco-friendly vehicle according to an embodiment of the present disclosure;

FIG. 2 is a graph illustrating signal waveforms of main parts or operations of the apparatus for controlling an on-board charger of an eco-friendly vehicle according to an embodiment of the present disclosure;

FIG. 3 is a schematic configuration diagram of an apparatus for controlling an on-board charger of an eco-friendly vehicle according to another embodiment of the present disclosure;

FIG. 4A is a diagram illustrating control of active power and reactive power of an apparatus for controlling an on-board charger of an eco-friendly vehicle according to an embodiment of the present disclosure;

FIG. 4B is a diagram illustrating control of active power and reactive power of an apparatus for controlling an on-board charger of an eco-friendly vehicle according to another embodiment of the present disclosure;

FIG. 5 is a graph simulating control of an apparatus for controlling an on-board charger of an eco-friendly vehicle according to an embodiment of the present disclosure; and

FIG. 6 is a block diagram of a computing device that can fully or partially implement an on-board charger of an eco-friendly vehicle according to an embodiment of the present disclosure.

### DETAILED DESCRIPTION OF ILLUSTRATIVE EMBODIMENTS

Hereinafter, specific example embodiments of the present disclosure will be described with reference to the drawings. The detailed descriptions that follow are provided to facilitate a comprehensive understanding of the methods, devices, and/or systems described herein. However, the disclosed embodiments are merely example embodiments and the present disclosure is not necessarily limited thereto.

In describing the example embodiments of the present disclosure, if it is determined that the detailed description of known technology related to the present disclosure may unnecessarily obscure the subject matter of the present disclosure, the detailed description thereof can be omitted. In addition, terms to be described later can be terms defined in consideration of functions in example embodiments of the present disclosure, which may vary according to the intention or custom of a user or operator for other embodiments. The terminology used in the detailed description can be merely for describing the example embodiments of the present disclosure and should in no way be necessarily limiting. Unless expressly used otherwise, singular forms of expression can include plural forms. In this description, expressions such as “comprising” or “comprising” are intended to indicate any characteristic, number, step, operation, element, portion, or combination thereof, one or more other than those described, and it should not be construed to exclude the existence or possibility of any other feature, number, step, operation, element, part, or a combination thereof.

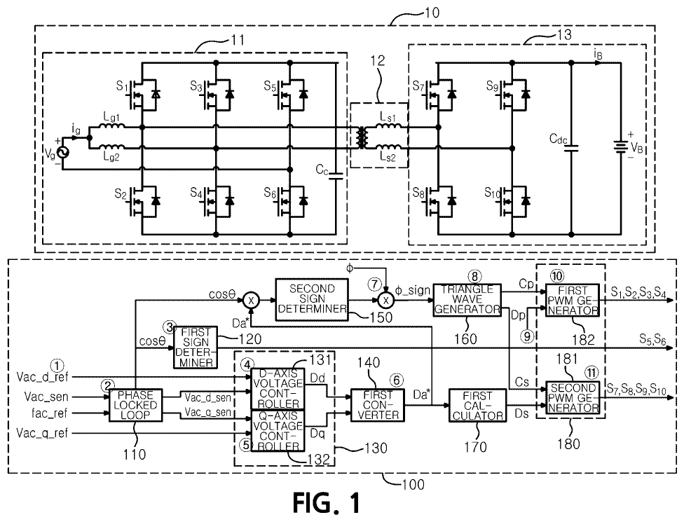

FIG. 1 is a schematic configuration diagram of an on-board charger system including an apparatus for controlling an on-board charger of an eco-friendly vehicle according to an embodiment of the present disclosure.

Referring to FIG. 1, the on-board charger system of an eco-friendly vehicle may include an on-board charger 10 and an apparatus for controlling an on-board charger of an eco-friendly vehicle 100 according to an embodiment of the present disclosure.

First, an on-board charger 10 may have a structure implementing the roles of an AC-AC converter and an AC-DC converter of the existing two-stage structure on-board charger into a single AC-DC converter, and may be a single-stage topology based on an Interleaved Totem-pole having an AC-AC converter 11, a transformer 12, and an AC-DC converter 13. The single-stage topology may achieve a high-frequency transformer 12 in which an alternating current fundamental wave ripple is removed from the transformer, and it can be possible to reduce an alternating current side high-frequency ripple, so the single-state topology may be a topology with a high possibility of achieving high efficiency/high power density.

The AC-AC converter 11 may include first to sixth switches (S₁ to S₆) performing an operation of controlling a PWM phase determining a direction of power and an AC-AC conversion operation. The AC-DC converter 13 may include seventh to tenth switches (S₇ to S₁₀) performing the role of power factor correction and an AC-DC conversion operation. The apparatus for controlling an on-board charger of an eco-friendly vehicle 100 may control switching operations of the first to sixth switches (S₁ to S₆) of the AC-AC converter 11 and the seventh to tenth switches (S₇ to S₁₀) of the AC-DC converter 13.

The apparatus for controlling an on-board charger for an eco-friendly vehicle 100 according to an embodiment of the present disclosure may include a phase locked loop 110, a first sign determiner 120, a voltage controller 130, a converter 140, a second sign determiner 150, a triangle wave generator 160, a first calculator 170, and a pulse width modulation (PWM) generator 180.

The phase locked loop 110 may receive a voltage value (Vac_sen) detecting a voltage of the alternating current (AC) power of the on-board charger 10 and a frequency value (fac_ref) of the AC power to phase lock phases thereof.

The first sign determiner 120 may generate a first control signal for controlling a switching operation of the AC-AC converter 11 by determining a sign of an output signal (cose) output from the phase locked loop 110, and generate a control signal, a portion of the first control signal, for controlling a switching operation of the fifth and sixth switches (S₅ and S₆) among the first to sixth switches (S₁ to S₆) of the AC-AC converter 11 and output the control signal.

The voltage controller 130 may receive a voltage command value (Vac_d_ref) (a d-axis voltage command value) of active power and a voltage command value (Vac_q_ref) (a q-axis voltage command value) of reactive power of a voltage (Vac) of the alternating current (AC) power. The voltage command value (Vac_d_ref) (the d-axis voltage command value) of the active power and the voltage command value (Vac_q_ref) (the q-axis voltage command value) of the reactive power may be received from a higher-level controller (not shown). In addition, a voltage value (Vac_d_sen) (a d-axis voltage) of active power and a voltage value (Vac_q_sen) (a q-axis voltage) of reactive power of a detection value (Vac_sen) obtained by detecting the voltage of the alternating current (AC) power may be received from the phase locked loop 110. The voltage controller 130 may include a d-axis voltage controller 131 and a q-axis voltage controller 132. The d-axis voltage controller 131 may receive a voltage value (Vac_d_sen) (a d-axis voltage) of active power and a voltage command value (Vac_d_ref) (a d-axis voltage command value) of active power to generate a first duty Dd for controlling the voltage of the active power. The q-axis voltage controller 132 may receive a voltage value (Vac_q_sen) (a q-axis voltage) of reactive power and a voltage command value (Vac_q_ref) (a q-axis voltage command value) of reactive power to generate a second duty Dq for controlling the voltage of the reactive power.

The converter 140 can convert a dq axis, which is the duty of the active power and reactive power, into a three-phase abc axis (dq to abc).

The second sign determiner 150 may determine a sign of a signal obtained by multiplying a conversion result (Da*) of the converter 140 and an output signal (cos θ) output from the phase locked loop 110.

The triangle wave generator 160 may generate a primary side carrier signal (Cp) and a secondary side carrier signal (Cs) based on a sign (ϕ_sign) obtained by multiplying the determination result of the second sign determiner 150 and a phase (ϕ) of the preset phase signal. There may be a phase difference between the primary side carrier signal (Cp) and the secondary side carrier signal (Cs) depending on the phase (ϕ) of the phase signal.

The first calculator 170 may calculate the conversion result from the converter 140 as a preset multiple. For example, the first calculator 170 may multiply the conversion result from the converter 140 by 0.5.

The PWM generator 180 may include first and second PWM generators 182 and 181, the first PWM generator 182 may generate a first control signal for controlling the switching operation of the AC-AC converter 11 according to the primary side carrier signal (Cp) from the triangle wave generator 160 and the preset primary side PWM duty (Dp), and generate a remaining control signal of the first control signal for controlling the switching operation of the first to fourth switches (S₁ to S₄) among the first to sixth switches (S₁ to S₆) of the AC-AC converter 11 and output the same. The primary side PWM duty (Dp) may be set according to a voltage value of the alternating current (AC) power of the on-board charger 10, and may be fixed to one of values of 0 to 1. For example, when the received voltage value of the alternating current (AC) power is 220V, the primary side PWM duty (Dp) may be set to 0.5, and when the received voltage value of the alternating current (AC) power is 110V, the primary side PWM duty (Dp) may be set to 0.3. The secondary side PWM generator 181 may generate a second control signal for controlling the switching operation of the seventh to tenth switches (S₇ to S₁₀) of the AC-DC converter 13 according to the secondary side carrier signal (Cs) from the triangle wave generator 160 and the secondary side PWM duty (Ds) from the first calculator 170 and output the same. The secondary side PWM duty (Ds) may be a calculation result of the first calculator 170.

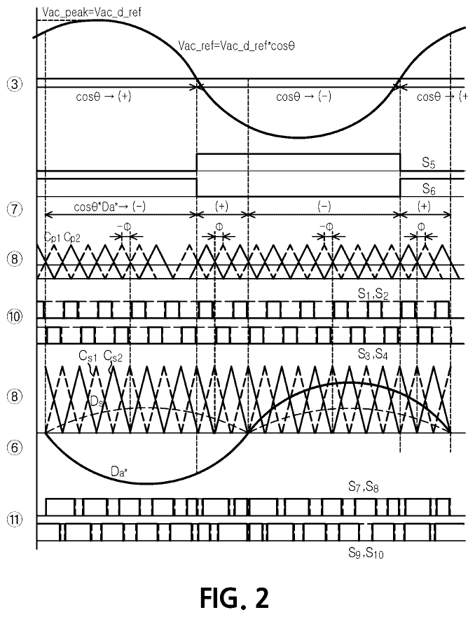

FIG. 2 is a graph illustrating signal waveforms of main parts or operations of an apparatus for controlling an on-board charger of an eco-friendly vehicle according to an embodiment of the present disclosure.

The signal waveforms of identification codes \textcircled{3}, \textcircled{6}, \textcircled{7}, \textcircled{8}, \textcircled{10}, and \textcircled{11} during the operation of the main parts of operations of the apparatus for controlling an on-board charger of an eco-friendly vehicle in FIG. 1 are indicated by the same identification codes \textcircled{3}, \textcircled{6}, \textcircled{7}, \textcircled{8}, \textcircled{10}, and \textcircled{11} in FIG. 2.

Referring to FIG. 2 together with FIG. 1, in the operation of the main parts or operations of the apparatus for controlling an on-board charger of an eco-friendly vehicle according to an embodiment of the present disclosure, the apparatus for controlling an on-board charger of an eco-friendly vehicle 100 according to an embodiment of the present disclosure may perform operations of: receiving a voltage value of alternating current (AC) power and a frequency value of the alternating current (AC) power of the on-board charger 10, to obtain a voltage value of active power and a voltage value of reactive power of the alternating current (AC) power (identification codes \textcircled{1} and \textcircled{2}), generating a first control signal for controlling the operation of a switch of the AC-AC converter 11 of the on-board charger 10 by determining a sign of a carrier signal by a phase-locked loop (identification codes \textcircled{3}, \textcircled{7}, \textcircled{8}, \textcircled{9}, and \textcircled{10}), and generating a second control signal for controlling the operation of a switch of the AC-DC converter 13 of the on-board charger 10 according to a duty signal generated according to the voltage value of the active power of AC power, the voltage value of the reactive power, and a preset voltage command value of the active power and a voltage command value of the reactive power (identification codes \textcircled{4}, \textcircled{5}, \textcircled{6}, and \textcircled{11}).

More specifically, first, the apparatus for controlling an on-board charger of an eco-friendly vehicle 100 according to an embodiment of the present disclosure may receive an active power voltage command value (Vac_d_ref) and a reactive power command value (Vac_q_ref) of the voltage (Vac) of alternating current (AC) power from a higher-level controller (identification code \textcircled{1}). Generally, when the on-board charger 10 operates in V2L, the active power voltage command value (Vac_d_ref) may be a voltage peak value of alternating current (AC) power (twice a root of a root mean square (rms)), and the reactive power command value (Vac_q_ref) may be zero. The phase locked loop 110 may receive a frequency value of the alternating current (AC) power from a higher level controller (not shown), and receive a voltage value (Vac_sen) of the alternating current (AC) power detected through a voltage sensor (not shown) and output a voltage value of active power (Vac_d_sen) (a d-axis voltage) and a voltage value of reactive power (Vac_q_sen) (a q-axis voltage) obtained by detecting the voltage of alternating current (AC) power using a phase difference between the input signal and the output signal (identification code \textcircled{2}).

In the operation of generating a first control signal for controlling the operation of a switch of the AC-AC converter 11 of the on-board charger 10 by determining a sign of a carrier signal by a phase locked loop (identification codes \textcircled{3}, \textcircled{7}, \textcircled{8}, \textcircled{9}, and \textcircled{10}), an output signal (cose) of the phase locked loop 110 may be a value (Vac_ref=Vac_d_ref*cose), which is the same phase as a load voltage command value (Vac_ref) from an upper controller (not shown), and the first sign determiner 120 may generate a control signal, which is a portion of the first control signal for controlling the switching operation of the fifth and sixth switches S₅ and S₆ of the AC-AC converter by determining a sign (+1/−1) of the output signal (cos θ) of the phase locked loop 110 (identification code \textcircled{3}).

The output signal (cos θ) of the phase locked loop 110 may be transmitted to a second sign determiner 150, and the second sign determiner 150 may determine a sign (+1/−1) of a signal obtained by multiplying the conversion result (Da*) of the converter 140 and the output signal (cos θ) output from the phase locked loop 110 (identification code \textcircled{7}). A result of the sign determination by the second sign determiner 150 may be multiplied by a phase (ϕ) of the phase signal, and a signal (ϕ_sign) obtained by multiplying the determination result of the second sign determiner 150 by the phase (ϕ) of the phase signal may be transmitted to a triangle wave generator 160.

The triangle wave generator 160 may generate a primary side carrier signal (Cp) and a secondary side carrier signal (Cs) based on a signal (ϕ_sign) obtained by multiplying the determination result of the second sign determiner 150 and a phase (ϕ) of the preset phase signal (identification code \textcircled{8}). There may be a phase difference between the primary side carrier signal (Cp) and the secondary side carrier signal (Cs) depending on the phase (ϕ) of the phase signal. Depending on the sign of the signal (ϕ_sign) obtained by multiplying the determination result of the second sign determiner 150 and the phase (ϕ) of the preset phase signal, the phases of the primary side carrier signal (Cp) and the secondary side carrier signal (Cs) may be either ahead or behind, and accordingly, a direction of a flow of power may be determined. That is, when the sign of the signal (ϕ_sign) obtained by multiplying the determination result of the second sign determiner 150 and the phase (ϕ) of the preset phase signal is ‘-’, which is a case in which the phase of the primary side (AC side) PWM controlling the AC-AC converter 11 is ahead of the phase of the secondary side (DC side) PWM controlling the AC-DC converter 13, power can be transmitted in a direction from AC to DC, and when the sign of the signal (ϕ_sign) obtained by multiplying the determination result of the second sign determiner 150 and the phase (ϕ) of the preset phase signal is ‘+’, the phase of the secondary side PWM is ahead of the phase of the primary side PWM, power flows in a direction from DC to AC.

The first PWM generator 182 of the PWM generator 180 may generate a remaining control signal of the first control signal controlling the switching operation of the first to fourth switches (S₁ to S₄) among the first to sixth switches (S₁ to S₆) of the AC-AC converter 11 according to the primary side carrier signal (Cp) from the triangle wave generator 160 and the preset primary side PWM duty (Dp) (identification code \textcircled{9}) (identification code \textcircled{10}). The duty (Dp) of the primary side PWM is a fixed value, and the value can be set from 0 to 1, and the setting value can be specified according to the input voltage.

In the operation of generating a second control signal for controlling the operation of the switch of the AC-DC converter 13 of the on-board charger 10 according to a duty signal generated a voltage value of active power and a voltage of reactive power of alternating current (AC) power and a preset voltage command value of the active power and a voltage command value of the reactive power (identification codes \textcircled{4}, \textcircled{5}, \textcircled{6}, \textcircled{11}), the d-axis voltage controller 131 of the voltage controller 130 may receive a voltage value (Vac_d_sen) (d-axis voltage) of active power and a voltage command value (Vac_d_ref) (d-axis voltage command value) of active power, to generate a first duty (Dd) for controlling the voltage of active power, the q-axis voltage controller 132 may receive a voltage value (Vac_q_sen) (q-axis voltage) of reactive power and a voltage command value (Vac_q_ref) (q-axis voltage command value) of reactive power, to generate a second duty (Dq) for controlling the voltage of reactive power (identification codes \textcircled{4}, \textcircled{5}). That is, the d-axis voltage controller 131 can output the first duty (Dd) by controlling the voltage value (Vac_d_sen) of active power to follow the voltage command value (Vac_d_ref) of active power (identification code \textcircled{4}). In addition, the q-axis voltage controller 132 may output a second duty (Dq) by controlling the voltage value (Vac_q_sen) of the reactive power to follow the voltage command value (Vac_q_ref) of the reactive power (identification code \textcircled{5}).

The converter 140 can convert the dq axis of the first and second duties (Dd, Dq), which are the duties of active power and reactive power, into the a three-phase abc axis (dq to abc) (identification code \textcircled{6}). The first calculator 170 can obtain the secondary side PWM duty (Ds) by multiplying the conversion result from the converter 140 by 0.5. Here, the reason for multiplying by 0.5 is to ensure that the value of the secondary side PWM duty (Ds) does not exceed 50% (0.5) of the secondary side carrier signal (Cs), for example.

The second PWM generator 181 of the PWM generator 180 may generate a second control signal for controlling the switching operation of the seventh to tenth switches (S₇ to S₁₀) of the AC-DC converter 13 according to the secondary side carrier signal (Cs) from the triangle wave generator 160 and the secondary side PWM duty (Ds) and output the second control signal (identification code \textcircled{11}).

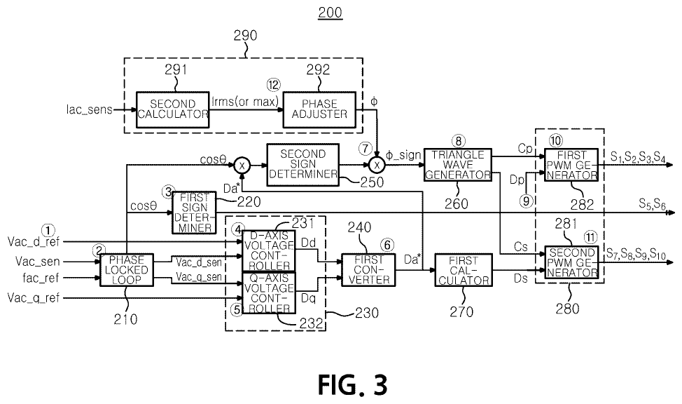

FIG. 3 is a schematic configuration diagram of an apparatus for controlling an on-board charger of an eco-friendly vehicle according to another embodiment of the present disclosure.

Referring to FIG. 3, an apparatus for controlling an on-board charger of an eco-friendly vehicle according to another embodiment of the present disclosure may further include a phase signal adjuster 290, as compared to the apparatus for controlling an on-board charger of an eco-friendly vehicle 100 according to an embodiment of the present disclosure shown in FIG. 1.

The phase signal adjuster 290 may adjust a phase (ϕ) of a phase signal according to a current (Iac_sen) of AC power of the on-board charger. The phase signal adjuster 290 may include a second calculator 291 and a phase adjuster 292. The second calculator 291 may calculate a root mean square (RMS) value or a maximum value of a load current of the on-board charger. The phase adjuster 292 may adjust the phase (ϕ) of the phase signal based on the calculated root mean square (RMS) value or maximum value of the load current. Based on the calculated root mean square (RMS) value or maximum value of the load current, the phase (ϕ) of the phase signal may be adjusted according to a map in which a relationship between the root mean square (RMS) value or maximum value of the load current and the phase is set in advance (identification code \textcircled{12}).

Except for the second calculator 291 and phase adjuster 292 of the above-described phase signal controller 290, the phase locked loop 210, the first sign determiner 220, the voltage controller 230, the converter 240, the second sign determiner 250, the triangle wave generator 260, the first calculator 270, and the PWM generator 280 of the apparatus for controlling an on-board charger of an eco-friendly vehicle according to another embodiment of the present disclosure illustrated in FIG. 3 have the same configurations and operations thereof as the phase locked loop 110, the first sign determiner 120, the voltage controller 130, the converter 140, the second sign determiner 150, the triangle wave generator 160, the first calculator 170, and the PWM generator 180 of the apparatus for controlling an on-board charger of an eco-friendly vehicle according to an embodiment of the present disclosure shown in FIG. 1, respectively; so detailed descriptions again thereof will be omitted.

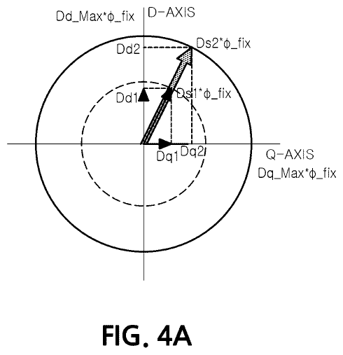

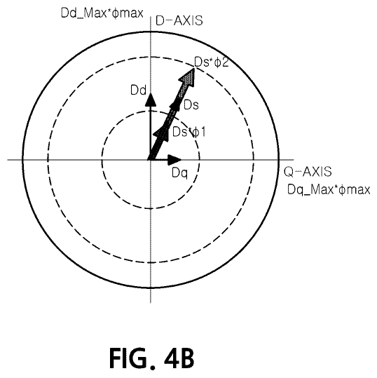

FIG. 4A is a diagram illustrating control of active power and reactive power of the apparatus for controlling an on-board charger of an eco-friendly vehicle according to an embodiment of the present disclosure of FIG. 1. FIG. 4B is a diagram schematically illustrating control of active power and reactive power of the apparatus for controlling an on-board charger of an eco-friendly vehicle according to another embodiment of the present disclosure of FIG. 3.

As described above, in the apparatus for controlling an on-board charger of an eco-friendly vehicle of the present disclosure, a secondary side of the apparatus, which is an AC-DC converter, individually converts a voltage of active power (d-axis) and a voltage of reactive power (q-axis), and a primary side of the apparatus, which is an AC-AC converter, illustrates control thereof when a fixed phase (ϕ) value is applied in FIG. 4A.

Referring to FIG. 4A, a maximum control range may be determined by Dd_max*ϕ_fix and Dq_max*ϕ_fix, and a magnitude and phase values may be determined by the first duty (Dd) and the second duty (Dq).

Referring to FIG. 4B, a case in which the phase (ϕ) value according to the magnitude of current (Iac1<Iac2) is set to a map (ϕ1<ϕ2) is briefly schematically shown.

The magnitude and phase thereof may be controlled using the first duty (Dd) and the second duty (Dq), and control stabilization may be achieved at low and high loads through appropriate control of the phase (ϕ) value. Accordingly, using one of the embodiments of the present disclosure, it can be possible to be stably controlled even in regions that cannot be controlled conventionally.

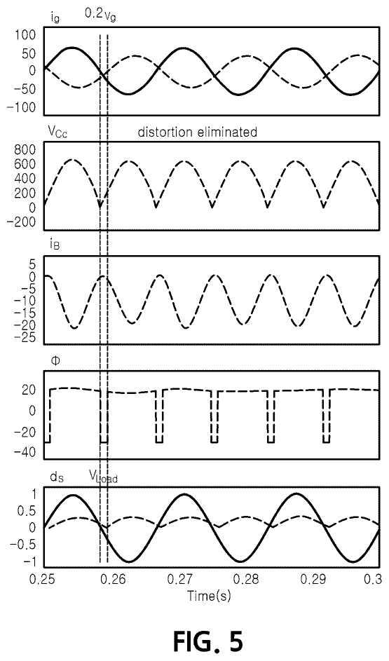

FIG. 5 is a graph simulating control of an onboard charger control device of an eco-friendly vehicle according to an embodiment of the present disclosure.

More specifically, this is a V2L operation waveform simulated under the conditions of apparent power S=7.2 kVA and power factor correction value PF=0.9 by connecting a RL load on a side of an alternating current (AC) of the onboard charger, for example. As a result of the simulation, it can be seen that θ occurs depending on a reactive power consumption of the load at a load voltage (V_{Load}).

It can be seen that a secondary side PWM duty (Ds) can follow a current shape of the AC power and maintain the shape without a fast discharge section V_{cc}, eliminating distortion in the shape of the voltage of AC power and maintaining total harmonic distortion (THD).

It was confirmed that the instantaneous power direction change was responded to through the polarity change of the phase (+) in the corresponding section, and it may be confirmed that the apparatus for controlling an on-board charger of an eco-friendly vehicle according to an embodiment of the present disclosure can smoothly perform control operations in the V2G mode and V2L mode.

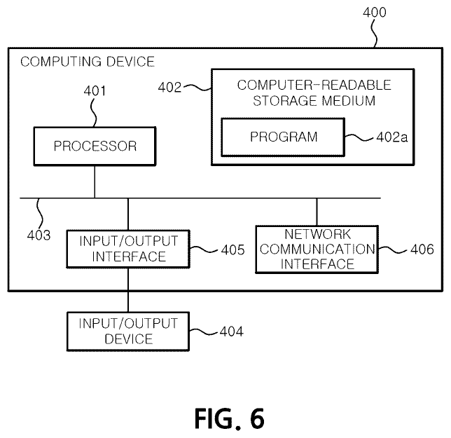

FIG. 6 is a block diagram of a computing device that can fully or partially implement an onboard charger control device for an eco-friendly vehicle according to an embodiment of the present disclosure, and may be the onboard charger control device shown in FIG. 1 and/or the onboard charger control device 200 shown in FIG. 3.

As shown in FIG. 6, the computing device 400 can include at least one processor 401, a computer-readable storage medium 402, and a communication bus 403, any combination of or all of which may be in plural or may include plural components thereof.

The processor 401 may cause the computing device 400 to operate according to the above-described example embodiments. For example, the processor 401 may execute one or more programs stored in the computer-readable storage medium 402. The one or more programs may include one or more computer executable instructions, wherein, when executed by the processor 401, the computer-readable executable instructions may be configured to cause the computing device 400 to perform operations according to an example embodiment of the present disclosure.

The computer-readable storage medium 402 may be configured to store computer-executable instructions or program code, program data, and/or other suitable forms of information. A program 402a stored on the computer-readable storage medium 402 can include a set of instructions executable by the processor 401. In an embodiment, the computer-readable storage medium 402 may include a memory (a volatile memory such as a random access memory, a non-volatile memory, or any suitable combination thereof), one or more magnetic disk storage devices, optical disk storage devices, flash memory devices, other forms of storage media that can be accessed by the computing device 400 and store desired information, or any suitable combination thereof.

The communication bus 403 interconnects various other components of the computing device 400, including the processor 401 and the computer-readable storage medium 402.

The computing device 400 may include one or more input/output interfaces 405 and one or more network communication interfaces 406 providing an interface for one or more input/output devices 404. The input/output interface 405 and the network communication interface 406 can be connected to the communication bus 403. The input/output device 404 may be connected to other components of the computing device 400 through the input/output interface 405. The example input/output device 404 may include an input device such as a pointing device (a mouse, a trackpad, or the like), a keyboard, a touch input device (a touchpad, a touchscreen, or the like), a voice or sound input device, various types of sensor devices, and/or a photographing device, and an output device such as a display device, a printer, a speaker, and/or a network card, for example. The example input/output device 404 may be included inside the computing device 400 as a component constituting the computing device 400, or may be connected to the computing device 400 as a separate device, distinct from the computing device 400.

Embodiments of the present disclosure may include a program for performing the methods described in this specification on a computer, and a computer readable recording medium including the program. The computer-readable recording medium may include program instructions, local data files, local data structures, or the like, alone or in a combination thereof. The medium may be specially designed and configured for the present disclosure, or may be commonly available in the field of computer software. Examples of the computer-readable medium may include a hardware device specially configured to store a magnetic medium such as hard disks, floppy disks and magnetic tapes, an optical recording medium such as CD-ROMs and DVDs, and program instructions such as ROM, RAM, and a flash memory and perform the same. Examples of the program may include not only machine language codes generated by a compiler, but also high-level language codes that may be executed by a computer using an interpreter.

As set forth above, according to an embodiment of the present disclosure, the problem that it may be difficult to be used under V2L load conditions in which an RLC value is instantaneously converted when controlling a charger, and that reactive power control may not be performed when an inductive load or capacitive load is connected may be solved.

Embodiments of the present disclosure are not necessarily limited to the above-described example embodiments and the accompanying drawings but can be defined by the appended claims. Therefore, those of ordinary skill in the art may make various replacements, modifications, or changes, and equivalents thereof, without departing from the scopes of the present disclosure defined by the appended claims.

What is claimed is:

1. An apparatus for controlling an on-board charger of a vehicle, the apparatus comprising:
one or more processors; and
a storage medium storing computer-readable instructions that, when executed by the one or more processors, enable the one or more processors to:
receive a first voltage value of alternating current (AC) power and a frequency value of the AC power of the on-board charger through a phase locked loop (PLL) to obtain a second voltage value of active power and a third voltage value of reactive power of the AC power,
generate a first control signal for controlling a first operation of a first switch group including pulse width modulation (PWM) phase control for controlling a power direction of an alternating-current-to-alternating-current (AC-AC) converter of the on-board charger by determining a first sign of a PLL output signal of the PLL, and
generate a second control signal for controlling a second operation of a second switch group of an alternating-current-to-direct-current (AC-DC) converter of the on-board charger according to a duty signal generated according to the second voltage value of the active power and the third voltage value of the reactive power of the AC power, and a preset first voltage command value of the active power and a second voltage command value of the reactive power thereof.

2. The apparatus of claim 1, wherein, in the generating of the first control signal, the instructions further enable the one or more processors to:
generate a first portion of the first control signal for controlling fifth and sixth switches among the first switch group of the AC-AC converter of the on-board charger by determining the first sign of the PLL output signal of the PLL; and
generate a second portion of the first control signal for controlling first to fourth switches among the first switch group of the AC-AC converter of the on-board charger by determining a second sign of a second signal obtained by multiplying the PLL output signal of the PLL and a three-phase converted signal of the duty signal.

3. The apparatus of claim 2, wherein, in the generating of the second portion of the first control signal, the instructions further enable the one or more processors to:
determine the second sign of the second signal obtained by multiplying the PLL output signal of the PLL and the three-phase converted signal of the duty signal;
generate a primary side carrier signal and a secondary side carrier signal according to a result of multiplying the second sign of the multiplied signal by a preset phase signal; and
generate the second portion of the first control signal according to the primary side carrier signal and a preset primary side PWM duty.

4. The apparatus of claim 3, wherein, in the generating of the second portion of the first control signal, the instructions further enable the one or more processors to adjust a phase of the phase signal according to a current of the AC power of the on-board charger.

5. The apparatus of claim 4, wherein, in the adjusting of the phase of the phase signal, the instructions further enable the one or more processors to:
calculate a root mean square (RMS) value of the current of the AC power or a maximum value of the current of the AC power of the on-board charger; and
adjust the phase of the phase signal based on the calculated RMS value or the maximum value of the current of the AC power.

6. The apparatus of claim 3, wherein, in the generating of the second control signal, the instructions further enable the one or more processors to:
generate a second duty signal of active power and a third duty signal of reactive power according to the second voltage value of the active power and the third voltage value of the reactive power of the AC power, and the preset first voltage command value of the active power and the second voltage command value of the reactive power of the AC power;
convert the second duty signal of the active power and the third duty signal of the reactive power into a three-phase duty signal; and
generate the second control signal based on a secondary side PWM duty obtained by calculating the three-phase duty signal at a preset ratio and the secondary side carrier signal.

7. A method for controlling an on-board charger of a vehicle, the method comprising:
receiving a first voltage value of alternating current (AC) power and a frequency value of the AC power of the on-board charger through a phase locked loop (PLL) to obtain a second voltage value of active power and a third voltage value of reactive power of the AC power;
generating a first control signal for controlling a first switch group including pulse width modulation (PWM) phase control for controlling a power direction of an alternating-current-to-alternating-current (AC-AC) converter of the on-board charger by determining a first sign of a PLL output signal of the PLL; and
generating a second control signal for controlling a second switch group of an alternating-current-to-direct-current (AC-DC) converter of the on-board charger according to a duty signal generated according to the second voltage value of the active power and the third voltage value of the reactive power of the AC power and a preset first voltage command value of the active power and a second voltage command value of the reactive power of the AC power.

8. The method of claim 7, wherein the generating of the first control signal comprises:
generating a first portion of the first control signal for controlling fifth and sixth switches among the first switch group of the AC-AC converter of the on-board charger, by determining the first sign of the PLL output signal of the PLL; and
generating a second portion of the first control signal for controlling first to fourth switches among the first switch group of the AC-AC converter of the on-board charger, by determining a second sign of a second signal obtained by multiplying the PLL output signal of the PLL and a three-phase converted signal of the duty signal.

9. The method of claim 8, wherein the generating the second portion of the first control signal comprises:
determining the second sign of the second signal obtained by multiplying the PLL output signal of the PLL and the three-phase converted signal of the duty signal;
generating a primary side carrier signal and a secondary side carrier signal according to a result of multiplying the second sign of the multiplied signal by a preset phase signal; and
generating the second portion of the first control signal according to the primary side carrier signal and a preset primary side PWM duty.

10. The method of claim 9, wherein the generating the second portion of the first control signal further comprises adjusting the phase of the phase signal according to the current of the AC power of the on-board charger.

11. The method of claim 10, wherein the adjusting of the phase of the phase signal comprises:
calculating a root mean square (RMS) value or a maximum value of the current of the AC power of the on-board charger; and
adjusting the phase of the phase signal based on the calculated RMS value or the maximum value of the current of the AC power.

12. The method of claim 9, wherein the generating of the second control signal comprises:
generating a second duty signal of the active power and a third duty signal of the reactive power according to the second voltage value of the active power and the third voltage value of the reactive power of the AC power, and the preset first voltage command value of the active power and the second voltage command value of the reactive power thereof;
converting the second duty signal of the active power and the third duty signal of the reactive power into a three-phase duty signal; and
generating the second control signal based on a secondary side PWM duty obtained by calculating the three-phase duty signal at a preset ratio and the secondary side carrier signal.

13. An apparatus for controlling an on-board charger of a vehicle, wherein the on-board charger includes an alternating-current-to-alternating-current (AC-AC) converter and an alternating-current-to-direct-current (AC-DC) converter, the apparatus comprising:
a phase locked loop (PLL) configured to:
detect a first voltage of alternating current (AC) power of the on-board charger,
detect a first frequency of the AC power of the on-board charger,
generate and output a sensed d-axis voltage value of active power and a sensed q-axis voltage value of reactive power based on the first voltage of AC power, and
output a PLL output signal;
a first sign determiner configured to:
receive the PLL output signal from the PLL,
determine a first sign of the PLL output signal, and
as a first part of generating a first control signal for controlling a first switch group of the AC-AC converter, generate a first portion of the first control signal for controlling fifth and sixth switches among the first switch group of the AC-AC converter based on the first sign and the PLL output signal, and
output the first portion of the first control signal to the fifth and sixth switches of the AC-AC converter;
a first voltage controller including a d-axis voltage controller and a q-axis voltage controller, wherein the first voltage controller is configured to:
receive, by the d-axis voltage controller, a d-axis voltage command value of active power based on the first voltage of AC power,
receive, by the q-axis voltage controller, a q-axis voltage command value of reactive power based on the first voltage of AC power,
receive, from the PLL by the d-axis voltage controller, the sensed d-axis voltage value of the active power,
receive, from the PLL by the q-axis voltage controller, the sensed q-axis voltage value of the reactive power,
generate and output, by the d-axis voltage controller, a first duty for controlling an active voltage of the active power, based on the d-axis voltage command value and the sensed d-axis voltage value, and
generate and output, by the q-axis voltage controller, a second duty for controlling a reactive voltage of the reactive power, based on the q-axis voltage command value and the sensed q-axis voltage value;
a first converter configured to:
receive, from the d-axis voltage controller, the first duty,
receive, from the d-axis voltage controller, the second duty, and
generate and output a three-phase-axis duty based on the first duty and the second duty;
a second sign determiner configured to:
receive the PLL output signal from the PLL,
determine the first sign of the PLL output signal,
receive the three-phase-axis duty from the first converter, and
multiply the first sign by the three-phase-axis duty to output a first signed three-phase-axis duty;
a triangle wave generator configured to:
receive the first signed three-phase-axis duty from the second sign determiner, receive a first phase,
multiply the first signed three-phase-axis duty by the first phase to generate a first phase sign, and
generate and output a primary side carrier signal and a secondary side carrier signal based on the first phase sign;
a first calculator configured to:
receive the three-phase-axis duty from the first converter, and
multiply the three-phase-axis duty by a preset multiplier to output a secondary side PWM duty;
a first PWM generator configured to:
receive the primary side carrier signal from the triangle wave generator,
receive a preset primary side PWM duty,
as a second part of the generating of the first control signal for controlling of the first switch group of the AC-AC converter, generate a second portion of the first control signal for controlling first to fourth switches among the first switch group of the AC-AC converter based on the primary side carrier signal and the preset primary side PWM duty, and
output the second portion of the first control signal to the first to fourth switches of the AC-AC converter; and
a second PWM generator configured to:
receive the secondary side carrier signal from the triangle wave generator,
receive the secondary side PWM duty from the first calculator,
generate a second control signal for controlling a second switch group of the AC-DC converter based on the secondary side carrier signal from the triangle wave generator and the secondary side PWM duty from the first calculator, and
output the second control signal to seventh to tenth switches of the second switch group of the AC-DC converter.

14. The apparatus of claim 13, wherein the apparatus comprises:
one or more processors; and
a storage medium storing computer-readable instructions that, when executed by the one or more processors, enable the one or more processors to provide functions and operations of the PLL, the first sign determiner, the first voltage controller, the first converter, the second sign determiner, the triangle wave generator, the first calculator, the first PWM generator, and the second PWM generator.
